(19) United States
(12) Patent Application Publication
(10) Pub. No.: US 2008/0297285 A1
(43) Pub. Date: Dec. 4, 2008

(54) Microwave Conducting Arrangement

(75) Inventors: Qi Chen, Maulburg (DE); Klaus Feisst, Stegen (DE); Eric Bergmann, Steinen (DE); Manfred Hammer, Wehr (DE)

Correspondence Address: BACON & THOMAS, PLLC, 625 SLATERS LANE, FOURTH FLOOR, ALEXANDRIA, VA, 22314-1176, US

(73) Assignee: Endress + Hauser GmbH + Co. KG, Maulburg (DE)

(21) Appl. No.: 10/586,561

(22) PCT Filed: Jan. 19, 2005
(86) PCT No.: PCT/EP2005/050211

§ 371 Date: Aug. 11, 2008

(30) Foreign Application Priority Data
Jan. 20, 2004 (DE) 10 2004 003 010.3

(51) Int. Cl. H01P 3/14; H01P 3/123; H01P 11/00; H01Q 13/02

(52) U.S. Cl. 333/241; 29/600; 343/786

(57) ABSTRACT

In order to provide a microwave-conducting arrangement, which is relatively easy, and thus cost-favorable, to fabricate, and which is suited also for complex structures and geometries, one or more electrically conductive layers are provided which are applied on a non-conductive body having a surface of any shape. A metallizing provided for such purpose on the surface of the body is, for example, produced by a vapor-deposition process, by means of a flame-spraying process, or by means of a chemical metallizing.

The invention relates to a microwave conducting arrangement, especially one based on a non-conductive structure, as well as to a method for its manufacture.

The term “microwave” refers herein to all electromagnetic waves and signals having a frequency greater than 1 GHz. These signals are used for a wide variety of technical applications, both in industrial processes, especially in the case of measurements technology, as well as also in the household, for example in so-called microwave ovens, as well as also in the case of medical applications.

In the technology of the applications, it is known to use thin, conductive layers applied on non-conductive, planar structures, such as e.g. microstrip lines on circuit boards, to serve essentially for conducting, or for radiating, microwaves. Also known from the technology of hollow conductors are metal, hollow conductors, for example rectangular, or round, hollow conductors, which are filled with suitable dielectrics. Dielectrica are also referred to as dielectrics, or dielectric materials. The singular of dielectrica is dielectricum.

Complex structures of hollow conductors, or such with complexly formed, geometric shapes, are difficult to fabricate with the known state of the art, and are, therefore, very costly. Known technologies, such as are used in the case of microstrip lines, are, since this involves more or less planar structures, likewise not suited for implementing complexly structured, three-dimensional, microwave conductors.

An object of the invention is, therefore, to provide a microwave-conducting arrangement, which is suited for complex structures and is, at the same time, cost-favorable, and relatively simple, to fabricate.

The object is achieved by a microwave-conducting arrangement of the invention, comprising a non-conductive body, on at least a part of whose shaped surface is applied an electrically conductive layer.

A special form of embodiment of the microwave-conducting arrangement of the invention is implemented on a body having a sinusoidally curved surface.

In yet other forms of embodiment of the microwave-conducting arrangement of the invention, the surface of the body is structured, and/or of elastic material.

A further microwave-conducting arrangement of the invention has an electrically conductive layer with a preferred thickness of 0.1-100 μm. In another preferred form of embodiment of the invention, the electrically conductive layer is manufactured by metallizing the surface of the body.

Still other forms of embodiment of the microwave-conducting arrangement of the invention concern the metallizing of the surface of the body by a flame-spraying method, by chemical metallizing, by galvanizing, or with a vapor deposition method, especially sputtering or PVD-, or CVD-, coatings.

In yet another microwave-conducting arrangement of the invention, the metallized coatings have a predetermined structure, for example gap-shaped omissions of the metallizing for the purpose of suppressing undesired modes or for the in-, or out-, coupling of HF-signals.

Still further forms of embodiment of the microwave-conducting arrangement of the invention include an externally metallized, cylindrical or conical, plastic body, which is usable as a hollow conductor, and an externally and internally metallized, plastic tube, which is usable as a coaxial conductor, as well as a funnel-shaped, internally metallized, plastic body, which us usable as a microwave antenna-horn.

Further and yet other forms of embodiment of the microwave-conducting arrangements are directed to an externally metallized, plastic body, which is usable as an in-coupling, and to a plastic body, which is composed of complex shapes and combines the functional elements of in-coupling, hollow conductor, and antenna horn.

The above-recited object is also achieved by a method for manufacturing a dielectric, microwave-conducting arrangement, wherein an electrically conductive and structured layer is applied to cover at least a portion of an any-shaped surface of a non-conductive body.

In another embodiment of the method of the invention, the electrically conductive layer is manufactured by metallizing the surface of the body by means of a vapor deposition method.

Furthermore, the invention relates to the use of a microwave-conducting arrangement on a sinusoidally curved surface of the body as a mode converter and to the use of a microwave-conducting arrangement of the invention having a funnel-shaped, internally metallized, plastic body as a dual-mode, antenna horn.

In comparison to the state of the art, the present invention involves, not planar, but, instead, three-dimensional, microwave-conducting structures. Many hollow conductors for technical applications comprise metal, hollow bodies, for example, a tube, which is filled with a dielectric material. By abandoning solid metal bodies, all kinds of microwave-conductive structures can, according to the invention, be manufactured especially simply and, therefore, cost favorably.

Thus, the invention permits, for example, creation of a microwave-conducting arrangement having sinusoidally curved surfaces; the arrangement serves, in such case, as a mode-converter. It also then becomes possible to manufacture microwave-conducting structures on specially structured surfaces for special antenna embodiments, which can only be manufactured with conventional technology at very great complexity and with accompanying greatly increased cost. The invention enables, also, the creation of any desired coating geometries, for example such with gap-shaped interruptions of the metallizing, which serve for suppressing undesired modes or for the in-coupling, or out-coupling, as the case may be, of microwave signals.

The invention is, moreover, distinguished by a simple manufacture of microwave-conducting structures when using different coating metals. It is especially suited for achieving defined chemical and physical properties in microwave-conducting structures, for example chemical resistance, defined thermal conductivity, as well as defined coefficient of thermal expansion, which would only be manufacturable in the case of conventional microwave-conducting arrangements by great technical complexity and, therefore, at high cost. By the applying of a plurality of different coating metals in the manufacture of a microwave-conducting structure, various physical and chemical properties can be combined, e.g. good thermal conductivity and chemical resistance. Moreover, the invention permits the construction of elastic, microwave-conducting structures.

The invention will now be explained and described in greater detail on the basis of various examples of embodiments, with reference being made to the appended drawing, the figures of which show as follows:

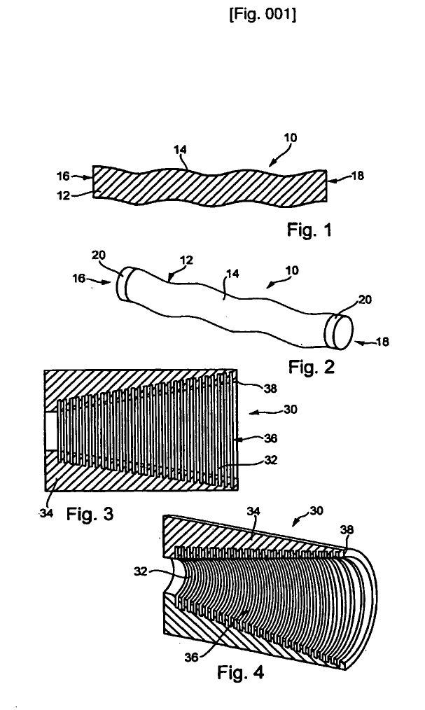

FIG. 1 a sectioned representation of one form of embodiment of a microwave-conducting arrangement of the invention;

FIG. 2 a three-dimensional representation of the microwave-conducting arrangement of FIG. 1;

FIG. 3 a sectional representation of another form of embodiment of a microwave-conducting arrangement of the invention usable as a dual-mode horn-antenna; and

FIG. 4 a three dimensional, sectioned representation of the microwave-conducting arrangement of FIG. 3.

FIG. 1 shows a longitudinal section of an example of an embodiment of a microwave-conducting arrangement 10 of the invention. A metal layer 14 is applied onto a non-conductive body 12 having a cylindrical, sinusoidally curved shape, so that the body has a conductive, lateral surface. The surface layer important for conducting microwaves is manufactured by metallizing. The body 12 in the example of an embodiment illustrated here is made of a dielectricum, thus, an insulator, for example PTFE. As a result of the metal layer 14 of the body 12, a round, hollow conductor is formed, filled with a dielectricum and curved sinusoidally. Microwaves in the GHz-range can be transported with this hollow conductor.

By the special shape, it is achieved that a hollow-conductor mode, for example the TE01-mode, fed-in at one end 16 (in FIG. 1, that is, for example, the left end), is, during travel through the microwave-conducting arrangement 10, converted into another mode and exits at the, in FIG. 1, right end 18 in the fundamental mode TE11. Such a mode-conversion is important for achieving an optimal antenna out-radiating characteristic.

Due to the special form and geometry of the arrangement 10 of a mode-converter, an implementation in terms of a conventional hollow-conductor, composed of a metal tube filled with dielectricum, would be possible only with great effort and high costs. In contrast, with the invention, the manufacturing effort sinks considerably, on the one hand, because of the relatively simple processing of the body 12 of plastic and, on the other hand, due to the subsequent metallizing. For such purpose, commonly used methods for metallizing of plastics can be applied, such as e.g. flame-spraying, chemical metallizing, and galvanizing, as well as vapor-deposition methods, such as sputtering or PVD-, or CVD-, coating (Chemical Vapor Deposition). A contacting of the metal layer can occur, for example, by soldering, conductive adhesives, welding, or by means of a spring contact.

For purposes of illustration, FIG. 2 shows a three-dimensional, side view of the arrangement 10 of the invention according to FIG. 1 involving the sinusoidally-shaped body 10. Preferably provided in the regions of the ends 16 and 18 are ‘normal’, cylindrical, lateral surface sections 20 of the body 12; these sections 20 simplify a connection to elements located up-, or down-, stream, such as e.g. an antenna, or a securement in a housing (not shown).

FIG. 3 shows, in longitudinal section, a further example of an embodiment of a microwave-conducting arrangement 30. This embodiment involves a horn antenna for radiating microwaves, for example in a frequency range around 26 GHz, wherein an inner surface of a non-conductive body 34 has a grooved surface structure 36.

The surface layer important for conducting microwaves is manufactured by metallizing of the body 34, which, as in the case of body 12, is made of a dielectricum, an insulator, for example PTFE. By the grooved surface structure 36, in addition to the hollow-conductor fundamental-mode, for example a TE11 mode, a higher mode, for example a TM11 mode, is excited. The superposition of the two modes to form a dual-mode antenna leads to a field distribution in the horn antenna, which disappears on the non-ideal edge 38.

To illustrate, FIG. 4 shows a three-dimensional section of the microwave-conducting arrangement 30 of the invention according to FIG. 3, as a dual-mode horn-antenna with the grooved surface structure 36 and the non-ideal edge 38. The metallizing of the grooved surface structure 36 can be performed with methods already described above in connection with FIGS. 1 and 2.

With a dual-mode horn-antenna of the invention as shown in FIGS. 3 and 4, it is possible, in simple manner, to avoid the disturbance reflections usually occurring on a non-ideal edge. Moreover, the manufacture of such a dual-mode horn-antenna can be considerably simplified with the invention as compared with a conventional dual-mode horn-antenna, and the antenna can be manufactured at lower cost. Instead of a usual, metal antenna-body, a more easily worked insulator, for example PVDF, is used as body 34. In simple manner, the grooved surface structure 36 can then be cut into the body 34 and the structured, internal surface subsequently metallized.

As the above-described examples of embodiments of microwave-conducting arrangements 10 and 30 illustrated in FIGS. 1 to 4 make clear, electrically conductive structures of the invention can be applied onto, basically, any non-conductive body 12, 34 of the most varied of geometries and forms. Even bodies 12, 34 of an elastic material can be used, so that fundamentally elastic, microwave-conducting arrangements of the invention can be created. In such case, externally metallized, cylindrical or conical insulators can serve as hollow conductors and/or in-couplers. Using the invention, microwave-conducting structures of complex geometry can be put into practice in especially simple manner. Thus, the invention permits the combining, for example, of an in-coupling, a hollow-conductor, and a horn-antenna into a single, microwave-conducting structure.

An electrically conductive layer of the invention with a thickness of 0.1 to 100 μm has been found to be especially effective.

Another special advantage of the invention is to be found in the fact that it permits a targeted and controlled metallizing in simple and cost-saving manner, so that special coating geometries, e.g. gap-shaped interruptions of the metallizing for suppression of undesired modes, are created. Moreover, by using different coating metals for a particular application, exactly defined, chemical and physical properties of the microwave-conducting structures can be created, such as e.g. chemical resistance, defined thermal conductivity, defined coefficient of thermal expansion, etc. By suitable choice of coating metals and layer sequence, also different properties can be combined by application of a plurality of layers.

### LIST OF REFERENCE CHARACTERS

10 microwave-conducting arrangement
12 body
14 metal layer
16 left end
18 right end
20 cylindrical, lateral surface sections
30 microwave-conducting arrangement
32 inner surface
34 non-conductive body
36 grooved surface structure
38 non-ideal edge

1-23. (canceled)

24. A microwave-conducting arrangement, comprises:
a non-conductive body, on at least a portion of whose surface of any shape are applied one, or more, electrically conductive layers.

25. The microwave-conducting arrangement as claimed in claim 24, wherein:
the surface of the body is curved sinusoidally.

26. The microwave-conducting arrangement as claimed in claim 24, wherein:
the surface of the body is structured.

27. The microwave-conducting arrangement as claimed in claim 24, wherein:
the body comprises elastic material.

28. The microwave-conducting arrangement as claimed in claim 24, wherein:
the electrically conductive layer has a preferred thickness of 0.1-100 μm.

29. The microwave-conducting arrangement as claimed in claim 24, wherein:
the electrically conductive layer is manufactured by metallizing the surface of the body.

30. The microwave conducting arrangement as claimed in claim 29, wherein:
the metallizing of the surface of the body is done in a flame-spraying process.

31. The microwave conducting arrangement as claimed in claim 29, wherein:
the metallizing of the surface of the body is implemented by chemical metallizing.

32. The microwave conducting arrangement as claimed in claim 29, wherein:
the metallizing of the surface of the body is manufactured by galvanizing.

33. The microwave conducting arrangement as claimed in claim 29, wherein:
the metallizing of the surface of the body is done with a vapor-deposition process, especially sputtering or PVD-, or CVD-, coating.

34. The microwave-conducting arrangement as claimed in claim 24, wherein:
the metallized coating has a predetermined structure, one with gap-shaped interruptions for suppressing undesired modes, or for the in- or out-coupling of microwave signals.

35. The microwave-conducting arrangement as claimed in claim 24, wherein: of concern, is an externally metallized, cylindrical or conical insulator, which is applied as a hollow conductor.

36. The microwave-conducting arrangement as claimed in claim 24, wherein:
of concern, is an externally and internally metallized, plastic tube, which is applied as a coaxial conductor.

37. The microwave-conducting arrangement as claimed in claim 24, wherein:
of concern, is a funnel-shaped, internally metallized, plastic body, which is applied as a microwave horn-antenna.

38. The microwave-conducting arrangement as claimed in claim 24, wherein:
of concern, is an externally metallized, plastic body, which is applied as an in-coupling.

39. The microwave-conducting arrangement as claimed in claims 35, wherein:
the plastic body is composed of complex shapes and combines the functional elements: In-coupling, hollow conductor, and horn-antenna.

40. The use of a microwave-conducting arrangement as claimed in claim 25 as a mode converter.

41. The use of a microwave-conducting arrangement as claimed in claim 37 having a non-ideal edge, as a dual-mode horn-antenna.

42. The method for manufacturing a dielectric, microwave-conducting arrangement, comprising the steps of:
providing a non-conductive body having a surface of any shape; and
applying an electrically conductive and structured layer applied to cover at least a portion of the surface.

43. The method as claimed in claim 42, further comprising the step of:
manufacturing the electrically conductive layer by metallizing the surface of the body by means of a vapor-deposition process.

44. The method as claimed in claim 42, further comprising the step of:
manufacturing the electrically conductive layer by metallizing the surface of the body by means of a flame-spraying process.

45. The method as claimed in claim 42, further comprising the step of:
applying the electrically conductive layer by metallizing the surface of the body by means of chemical metallizing.

46. The method as claimed in claim 42, further comprising the step of:
manufacturing the electrically conductive layer by metallizing the surface of the body by means of galvanizing.
